(19) United States
(12) Patent Application Publication
(10) Pub. No.: US 2024/0353543 A1
(43) Pub. Date: Oct. 24, 2024

(54) TIME OF FLIGHT SENSOR

(71) Applicant: ams International AG, Jona (CH)

(72) Inventors: Ryan OWEN, Plano, TX (US); Pradeep HEGDE, Frisco, TX (US)

(21) Appl. No.: 18/685,879

(22) PCT Filed: Aug. 23, 2022
(86) PCT No.: PCT/EP2022/073500

§ 371 Date: Feb. 22, 2024

(30) Foreign Application Priority Data
Aug. 24, 2021 (GB) 2112099.3

(51) Int. Cl. G01S 7/487; G01S 7/4863; G01S 17/10; G01S 17/86

(52) U.S. Cl. CPC G01S 7/4876; G01S 7/4863; G01S 7/4873; G01S 17/10; G01S 17/86

(57) ABSTRACT

An optical device includes an emitter for emitting pulses of light, a detector for detecting light emitted by the emitter and reflected from one or more targets, and one or more processors. The detector includes a plurality of detection zones covered by a lens arranged to direct incident light onto the plurality of zones. The detector is configured to provide an output signal from each detection zone. The one or more processors are configured to process the output signals, dynamically set a signal threshold for the one or more targets, filter out output signals having an amplitude below the signal threshold, determine a distance to the one or more targets, group the one or more targets based on the distance to each target, and set the signal threshold for each group of targets based on the output signals of the one or more targets in the group of targets.

### FIELD OF DISCLOSURE

The present disclosure concerns optical devices such as time of flight (TOF) sensors and methods of detection applicable to such.

### BACKGROUND

Time of flight (TOF) sensors measure the time between emitting a pulse of light and receiving a reflection from an object to determine the distance to the object. TOF sensors are therefore useful for ranging applications, proximity sensing and similar.

Light scattered within the sensor itself can be a problem and give rise to false positive results. For example, light can be reflected or diffracted between the sensor plane and an overlying lens, causing readings in multiple locations on the sensor.

It is difficult to physically alter the lens to prevent scattering, and simply increasing detection thresholds decreases sensitivity of the sensor.

### SUMMARY

To at least partially solve this problem the present disclosure provides a TOF sensor that is configured to filter out false positive signals, in order to accurately detect true targets in front of the sensor.

According to a first aspect of the present disclosure there is provided an optical device (e.g. a TOF sensor) comprising an emitter for emitting pulses of light, and a detector for detecting light emitted by the detector and reflected from one or more targets. The detector comprises a plurality of detection zones (e.g. 3×3, 4×4 etc.) covered by a lens arranged to direct incident light onto the plurality of zones, and wherein the detector is configured to provide an output signal from each detection zone. The device further comprises one or more processors for processing the output signals, wherein the processor(s) is configured to dynamically set a signal threshold for the one or more targets, and to filter out output signals having an amplitude below the signal threshold. The emitter is typically a vertical cavity surface emitting laser (VCSEL), which may, for example, operate at a frequency in the range of 850 nm to 1400 nm (e.g. 940 nm). The emitter may comprise a microlens array for shaping the output beam. The detector typically comprises an array of single photon avalanche diodes (SPADs), wherein each detection zone may comprise a plurality of SPADs. The number of zones can be changed depending on the application. For example, for detecting a large number of objects the SPADs may be used to provide 64×64 zones. Some detector elements may also be part of multiple zones. The lens may be a collector lens formed directly on the detector surface.

The processor(s) can be configured to determine a distance to the one or more targets (from the time of arrival of received light), group the one or more targets into one or more groups of targets based on the distance to each target, and for each group of targets, set the signal threshold for the group of targets based at least partly on the output signals of the one or more targets in the group of targets. Multiple targets at a similar distance (e.g. within 5%, or 10% of each other) can be grouped together and a different signal threshold applied to each group. Typically the device may comprise a time to digital converter (TDC) and histogram memory for determining the time of arrival and thereby the distance to the one or more targets. The optical device may comprise an on-chip processor for determining the signal amplitudes of the output signals and the distances to the one or more targets, and one or more further “off-chip” processors for grouping targets and for dynamically setting the signal thresholds. In his case, the on-chip processor can provide the amplitudes and distances to the off-chip processor(s), usable for grouping the targets and for setting the thresholds. The off-chip processor(s) may be located in a host device (e.g. smartphone) in which the device is integrated.

The processor(s) can be configured to determine a maximum output signal for the group of targets and set the signal threshold based at least partly on the maximum output signal. For example, the threshold applied to a group can be a percentage of the maximum output signal from target in that group.

The processor(s) can be configured to map the distance of a group of targets to a threshold factor, and to set the signal threshold of the group of targets based at least partly on the threshold factor. For example, an appropriate mapping of distance to threshold factor may be created from calibration trials and then accessed by the processor. This allows the threshold value to be more specifically tailored to specific applications and different types of expected targets.

The processor(s) can also be configured to dynamically set the signal threshold for each zone that detects a target of the group of targets. That is, the threshold value is not necessarily constant for the whole group, but may be different depending on the detection zone. For example, the processor(s) can be configured to map the zone to a threshold factor and the signal threshold for the zone is at least partly determined by the threshold factor. There may be a single mapping from both the distance and zone to a threshold factor.

According to a second aspect of the present disclosure there is provided an autofocus camera system comprising an optical system according to the first aspect, wherein the system is configured to automatically set a focus based on the one or more targets detected by the optical system. The optical system allows for true multi target and multizone autofocusing.

According to a third aspect of the present disclosure there is provided a method of detecting one or more targets. The method comprises emitting a pulse of light, receiving in one or more zones of a detector emitted light reflected from the one or more targets, and for each zone, providing an output signal based on the received light The method further comprises setting a signal threshold for the one or more targets and filtering out output signals with an amplitude below the signal threshold. The method may be carried out using an optical device according to the first aspect.

The method may further comprise determining a distance to the one or more targets, grouping the one or more targets into one or more groups of targets based on the distance to each target, and for each group of targets, setting the signal threshold for the group of targets based at least partly on the output signals of the one or more targets in the group of targets. As targets/objects appear and disappear or move closer or further away from the device, the threshold can be dynamically updated.

The method may further comprise determining a maximum output signal for the group of targets and setting the signal threshold based at least partly on the maximum output signal. The method may comprise mapping the distance of a group of targets to a threshold factor, and setting the signal threshold of the group of targets based at least partly on the threshold factor.

The method may comprises setting the signal threshold for each group of targets and for each zone that detects a target of the group of targets. Hence, the threshold can be adjusted for specific zones in which the target is detected. The method can comprise mapping the zone to a threshold factor and determining the signal threshold at least partly based on the threshold factor.

### BRIEF DESCRIPTION OF THE PREFERRED EMBODIMENTS

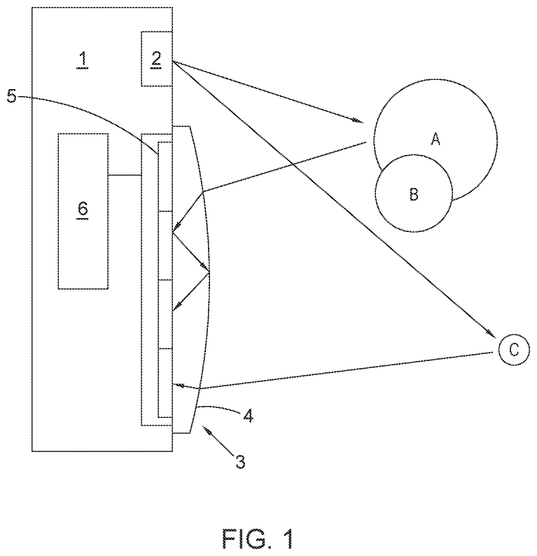

FIG. 1 shows a schematic diagram of an optical device according to an embodiment;

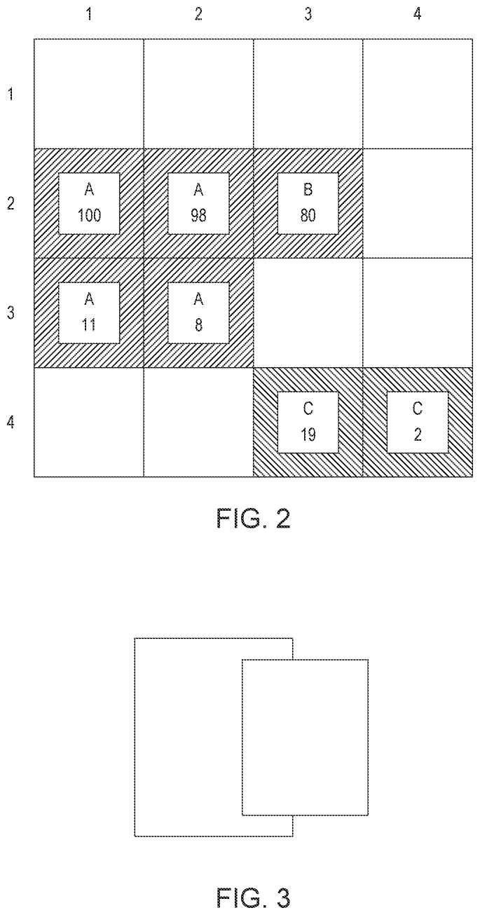

FIG. 2 shows a schematic diagram of a part of detector according to an embodiment;

FIG. 3 shows a test setup;

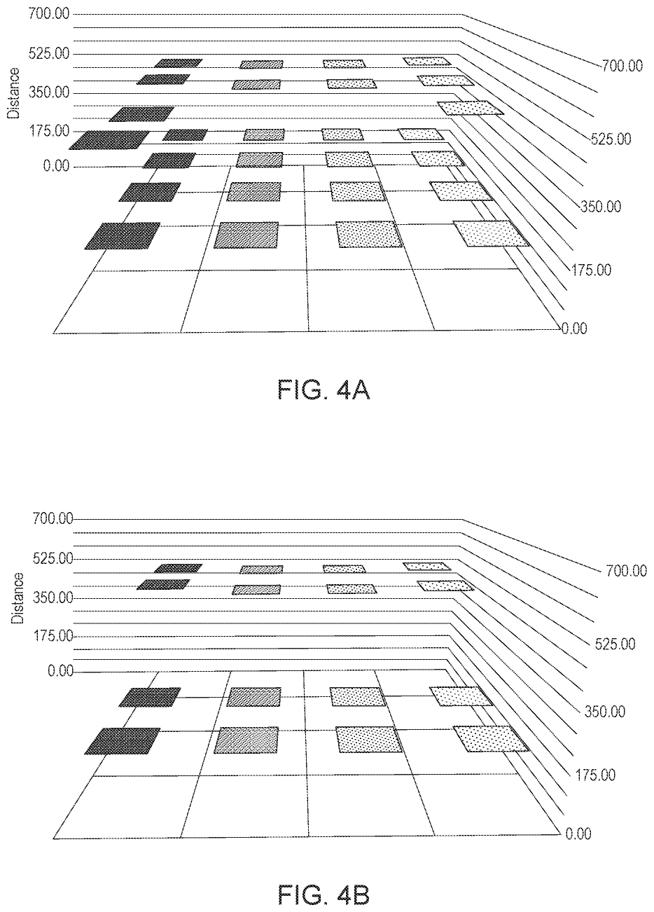

FIG. 4A shows the results from the test setup without dynamic filtering; and

FIG. 4B shows the results from the test setup with dynamic filtering.

### DETAILED DESCRIPTION

FIG. 1 shows a schematic diagram of an optical device 1 being a TOF sensor according to an embodiment. The sensor comprises an emitter 2 and a detector 3. The emitter (e.g. a VCSEL) is configured to emit light pulses, which are reflected from targets A, B and C in front of the sensor. A portion of the reflected light is incident on the detector 3 through the lens 4. The targets A, B and C are located at different positions within the field of view of the detector 3 and are mainly detected in different detection zones 5 of the detector. Each zone 5 typically comprises an array of detector elements (e.g. SPADs) and provide output signals in response to receiving the reflected light. The sensor further comprises a processor 6 for processing the output signals from the detector 3 in order to determine the distance to and/or presence of to the targets A. B and C.

Four detection zones 5 of the detector 3 are seen in the diagram. Counting from the top, targets A and B will be mainly detected in the second zone 5 (i.e. the greatest intensity of light reflected from A and B is incident on the second zone). However, a portion of the incident light is scattered from the detector surface and gives rise to a false positive detection in the third zone 5. Target C is mainly detected in the fourth zone 5.

In order to filter out false positive detections, the processor 6 is configured to dynamically set the signal threshold for each zone. For example, the processor 6 an be configured to group targets based on their distance from the sensor, and different signal thresholds can be set for each group. Typically, targets further away will naturally have a lower signal amplitude, and so a low threshold value has to be used to avoid filtering out true targets, while for objects close to the sensor, a higher signal threshold may be set. The threshold can be set as a percentage of the maximum signal of a group of targets, and may be further adjusted based on the particular zone of the detector. For example, corner zones may have a lower threshold value, as the signal output from corner zones tends to be smaller than from zones 5 closer to the middle of the detector 3.

The proposed dynamic threshold filtering can compare the signal amplitude among zones that detect the same target to filter out scattering artefacts and “fake” targets. For a given target, one or more of the zones is receiving the most amount of light from the actual target. Other zones are reporting a partial signal from the same target and/or signal from a scattering artefact. Zones that see the same target are grouped together to keep multi-target functionality. Thresholds can be calibrated across distances and across zone location within the multizone sensor array.

FIG. 2 shows schematic front view of the detector 3, wherein zones detecting a target are filled and labelled with the target A, B or C giving rise to the positive reading and a relative amplitude. Since targets A and B are located at a similar distance (e.g. within 10% of each other) the processor 6 groups them into a first group. Target C is located further away and is therefore grouped in a second group. The processor 6 determines the maximum output signal of each group. In the first group, the maximum output signal is 100 from target A in zone (1:2), while in the second group the maximum output signal is 19 in zone (3:4).

The processor 6 is configured to determine a threshold factor for each detection zone 5 with a positive reading based on the distance to the associated group and optionally based on the location of the zone 5. The threshold value of a zone is the determined by combining the maximum output signal and the threshold factor. For example, for the first group the threshold factor is 0.2 and the for the second group the threshold factor is 0.15. The signal threshold value for the first group is then 100×0.2=20, and the signal threshold value for the second group is 19*0.15=2.85. The processor 6 will then filter out the output signals in detection zones (1:3), (2:3) and (4:4).

In general, the device can be used as follows:
A Group targets based on reported target distance
B. For each group:
1. Find maximum signal amplitude Sm of target within a group
2. For each target in the group:
I. Map reported target distance and zone location to calibration filter threshold F_{TH}
II. Apply threshold to maximum signal within the group to determine the Signal threshold:

$${S}_{TH} = {S}_{m} * {F}_{TH}$$

III. If the target signal amplitude S_{A} is less than the Signal threshold (S_{A}<S_{TH}), filter out this target

FIG. 3 shows a schematic diagram of a test setup with two flat objects partially overlapping with one located in front of the other.

FIGS. 4A and 4B shows the resulting readings from the test setup in FIG. 3 from an optical device without filtering (FIG. 4A) and with filtering (FIG. 4B). Distance from the sensor is plotted on the vertical axis. As can be seen in FIG. 4A, there are a large number zones are providing of false positive output signals for the object in front (closest to the sensor) and three zones providing false positive readings for the object at the back. These false positive readings are removed (filtered out) in FIG. 4B.

Although specific embodiments have been described above, the claims are not limited to those embodiments. Each feature disclosed may be incorporated in any of the described embodiments, alone or in an appropriate combination with other features disclosed herein.

Reference Numerals

| | |
|---|---|
| 1 | Optical device |
| 2 | Emitter |
| 3 | Detector |
| 4 | Lens |
| 5 | Detection zones |
| 6 | Processor |

1. An optical device comprising:
an emitter for emitting pulses of light;
a detector for detecting light emitted by the emitter and reflected from one or more targets, wherein the detector comprises a plurality of detection zones covered by a lens arranged to direct incident light onto the plurality of zones, and wherein the detector is configured to provide an output signal from each detection zone; and
one or more processors configured to:
process the output signals;
dynamically set a signal threshold for the one or more targets;
filter out output signals having an amplitude below the signal threshold;
determine a distance to the one or more targets;
group the one or more targets into one or more groups of targets based on the distance to each target; and
for each group of targets, set the signal threshold for the group of targets based at least partly on the output signals of the one or more targets in the group of targets.

2. (canceled)

3. The optical device according to claim 1, wherein the one or more processors are further configured to:
determine a maximum output signal for the group of targets; and
set the signal threshold based at least partly on the maximum output signal.

4. The optical device according to claim 1, wherein the one or more processors are further configured to:
map the distance of a group of targets to a threshold factor; and
set the signal threshold of the group of targets based at least partly on the threshold factor.

5. The optical device according to claim 1, wherein the one or more processors to are further configured to:
dynamically set the signal threshold for each group of targets and for each zone that detects a target of the group of targets.

6. The optical device according to claim 5, wherein the one or more processors are further configured to:
map the zone to a threshold factor, wherein the signal threshold for the zone is at least partly determined by the threshold factor.

7. An autofocus camera system comprising an optical system according to claim 1, wherein the autofocus camera system is configured to automatically set a focus based on the one or more targets detected by the optical system.

8. A method of detecting one or more targets, the method comprising:
emitting a pulse of light;
receiving in one or more zones of a detector emitted light reflected from the one or more targets;
for each zone, providing an output signal based on the received light;
setting a signal threshold for the one or more targets;
filtering out output signals with an amplitude below the signal threshold;
determining a distance to the one or more targets;
grouping the one or more targets into one or more groups of targets based on the distance to each target; and
for each group of targets, setting the signal threshold for the group of targets based at least partly on the output signals of the one or more targets in the group of targets.

9. (canceled)

10. The method according to claim 8, further comprising:
determining a maximum output signal for the group of targets; and
setting the signal threshold based at least partly on the maximum output signal.

11. The method according to claim 8, further comprising:
mapping the distance of a group of targets to a threshold factor; and
setting the signal threshold of the group of targets based at least partly on the threshold factor.

12. The method according to claim 8, further comprising:
setting the signal threshold for each group of targets and for each zone that detects a target of the group of targets.

13. The method according to claim 12, further comprising:
mapping the zone to a threshold factor and determining the signal threshold at least partly based on the threshold factor.
